(19) United States
(12) Patent Application Publication
(10) Pub. No.: US 2026/0035487 A1
(43) Pub. Date: Feb. 5, 2026

(54) CELLULOSE DISSOLUTION, EMULSIONS THEREOF, COMPOSITIONS THEREFROM, AND PROCESS OF MAKING CELLULOSE-BASED BINDERS AND ADHESIVE THEREFROM

(71) Applicant: Silvis Materials, Inc., Boulder, CO (US)

(72) Inventors: Dhrubojyoti D. Laskar, Erie, CO (US); Chi-Linh Do-Thanh, Boulder, CO (US); Patricia J. Ferreira, Boulder, CO (US)

(73) Assignee: Silvis Materials, Inc., Boulder, CO (US)

(21) Appl. No.: 19/276,409

(22) Filed: Jul. 22, 2025

Related U.S. Application Data
(60) Provisional application No. 63/678,629, filed on Aug. 2, 2024.

(51) Int. Cl. C08B 1/00

(52) U.S. Cl. CPC C08B 1/003

(57) ABSTRACT

Disclosed herein is a novel method for making bio-based emulsion or dispersion, utilizing unaltered natural cellulose as the primary raw material. The method employs environmentally friendly and non-toxic dissolution systems, such as custom-designed ionic liquids (ILs) and deep eutectic solvents (DESs), for dissolution of cellulose. Subsequently, this dissolved cellulose composition is combined with emulsifying agents to yield a stable emulsion. A solvent removal process is further employed to separate the cellulose-based emulsion from the dissolution system, enabling recovery and reuse of the solvent. Finally, mixing with bio-based additives and crosslinking agents, the resulting product is an aqueous cellulosic-derived colloidal emulsion and/or dispersion, that is useful as bio-based binders and adhesives, which is also biodegradable and compostable, offering a sustainable alternative to petroleum-based adhesives/binders across a range of applications.

### CROSS-REFERENCE TO RELATED APPLICATIONS

Priority is hereby claimed to provisional application Ser. No. 63/678,629, filed Aug. 2, 2024, which is incorporated herein by reference.

### TECHNICAL FIELD

Disclosed herein is a method of formulating bio-based emulsions, more specifically cellulose-based emulsions and/or dispersions. The emulsions and dispersions are useful in a host of end uses, including as binders and adhesives. Additionally, the method includes complete dissolution of cellulose in non-toxic and green solvents, followed by emulsification using emulsifiers. In particular, the method may optionally include removal and recovery of dissolution solvents during and/or after emulsification to yield an aqueous colloidal emulsion/dispersion of cellulose. The cellulose-enriched composition of matter may optionally be mixed with bio-based additives and/or crosslinking agents to produce cellulosic-based formulations which can then be used as bio-based and biodegradable binders, adhesives, films, and the like.

### BACKGROUND

The persistent dependence on non-renewable and petroleum-based products poses a severe threat to the fragile balance of the world's ecosystem. Currently, the production of coatings and binders/adhesives is limited by the conventional raw materials used. These materials are primarily fossil-fuel based. Given that fossil fuels are identified as the primary source of emissions affecting our climate, industries across the board face constraints due to the lack of cost-effective and bio-based/renewable/recyclable alternatives. Government mandates, growing social consciousness, and environmental anxieties underscore the pressing need for a solution to address climate change and promote a more sustainable future. Reducing the carbon footprint in the adhesive and binder industry is a specific focus within the broader effort to make industrial processes more sustainable. Adhesives and binders are used in a wide range of applications, from construction to manufacturing, and they can contribute to carbon emissions through their production and usage. Developing adhesives and binders from biodegradable and/or bio-based materials, such as cellulose and other plant-based polymers, can significantly reduce carbon emissions compared to traditional petroleum-based counterparts. Deployment of cellulosic materials in the manufacturing of adhesives and binders will thus promote a necessary transition toward sustainable alternatives.

Cellulose stands as an exceptionally abundant and renewable organic resource. Globally, cellulose accounts for roughly 1.5×10¹² tons of the planet's total annual biomass production. Cellulose garners significant industrial interest due to its outstanding attributes such as sustainability, biodegradability, and non-toxicity. Cellulose is the predominant constituent of biomass more broadly, accounting for up to 50% of its dry weight. It consists of extended, linear fibrils composed of β-(1,4) glucopyranoside chains, typically having a native degree of polymerization (DP) ranging from roughly 5000 to 15,000. Nevertheless, the full potential of cellulose remains untapped in various application domains. The primary hindrance to the wider application of cellulose lies in its natural unsuitability for most purposes, thus requiring the utilization of cellulose derivatives. Natural cellulose has an intrinsically anisotropic molecular structure. Due to its robust hydrogen bonding and high crystalline structure, cellulose can be challenging to dissolve, melt, and process. Currently, the cellulose industry is increasingly focused on developing non-toxic and environmentally friendly solvents and dissolution methods, marking a significant area of advancement. Several cellulose dissolution methodologies have been disclosed, employing environmentally friendly and non-toxic solvents. These developments are a significant advancement in this field. However, it is important to note that the conventional methods for processing cellulose require elevated temperatures and the incorporation of additional processing steps to activate cellulose for dissolution.

Water-based adhesives and binders are known for their superior environmental qualities as compared to organic solvent-based alternatives. Water-based adhesives and binders have lower emissions of volatile organic compounds (VOCs) and possess a smaller carbon footprint than organic alternatives. The realm of aqueous emulsion solutions, adhesives, and binders offers a range of innovative methods tailored to diverse applications. A series of patents addresses diverse areas of innovation in this area. See, for instance, U.S. Pat. No. 9,644,106, which focuses on developing a specialized aqueous emulsion solution for inkjet printing; the method aims to reduce ink viscosity, especially for high-speed printing. U.S. Pat. No. 10,344,478 discloses an adhesive binder composition tailored for attaching paper sheets to gypsum articles by extending the adhesive's open time. This quality is particularly beneficial for paper-faced gypsum boards. U.S. Pat. No. 8,931,228 addresses construction materials with a pre-applied waterproofing membrane for concrete surfaces, enhancing resistance to blocking and immersion. U.S. Pat. No. 8,530,608 explores an eco-friendly water-based adhesive for laminating plastic films to metal substrates, enabling efficient metal-to-plastic lamination. Published U.S. Patent Appl. US 2023/0183529 discloses sprayable water-based adhesive compositions for various applications, incorporating elastomeric adhesive polymers and hollow polymeric microspheres coated with barrier materials.

Numerous advancements in the field of bio-based materials deserve attention are also described in the recent patent literature. For example, U.S. Pat. No. 11,525,024 discloses bio-based block copolymers derived from phenolic acrylate monomers. The monomers are obtained from lignin-containing biomass feedstocks. They find use in pressure-sensitive adhesives, binders, and polymer electrolytes. Another notable patent, U.S. Pat. No. 11,466,187, enhances a silicone-based adhesive with cellulose nanocrystals, thereby increasing its water uptake capacity. U.S. Pat. No. 9,000,073 describes an aqueous adhesive composition with predictable and adjustable viscosity. U.S. Pat. No. 10,584,094 discloses plant oil-based acrylic monomers for emulsion polymerization. In sustainable packaging, U.S. Pat. No. 8,871,319 describes flexible bio-based barrier packages, while U.S. Pat. No. 11,098,134 describes cellulose-containing materials having improved wear resistance. Lastly, U.S. Pat. No. 10,433,543 describes bioactive and biodegradable polyhydroxyalkanoate (PHA)-based films and coatings for controlled release in agricultural applications, such as films for silage bales, mulch films, planting pots, and other containers.

However, none of these aforementioned patents and publications provide a method and/or compositions that harnesses the full potential of unmodified cellulose as a primary component. In addition, the existing approaches do not fully exploit the potential of integrating cellulose dissolution techniques with emulsification processes to create unique cellulose-based emulsions and dispersions, in which cellulose is a significant part of the dispersed phase. Consequently, there is an ongoing and unmet need for an approach to cellulose utilization that is industrially feasible, economical, and simple to implement, and which yields stable cellulosic emulsions and/or dispersions for making adhesives and binders. There is also a need for the development of improved bio-based binder and adhesive compositions which are fully bio-degradable, compostable, and recyclable. There additionally is a need to significantly expand the flexibility of cellulosic emulsions/dispersions, enabling them to benefit from optional supplementary ingredients such as stabilizers, crosslinking agents, softening agents, colorants, and the like without compromising their performance. These and other needs are addressed by the method disclosed herein.

### SUMMARY

The present disclosure provides an effective, efficient, and cost-effective method for utilizing various cellulosic feedstocks, such as pulps from trees, grasses, and agricultural residues, to produce cellulosic-derived adhesives and binders. This disclosure broadly describes an economical and environmentally friendly process that includes the dissolution of cellulose, utilizing the dissolved cellulose to form cellulosic emulsions and dispersions, and further treating these emulsions/dispersions by blending them with additives, such as bio-based polymers and/or bio-based crosslinking agents, to create aqueous based cellulose-derived binders and adhesives as replacements for petroleum-based adhesive and binder formulations.

Disclosed herein is a method for the dissolution of cellulose employing non-toxic and green solvents such as Ionic Liquids (ILs) and Deep Eutectic Solvents (DESs). The described method involves the selection of appropriate ILs and DES dissolution systems and optimization of dissolution conditions, including temperature and mixing time, to achieve high dissolution efficiency. Under cellulose dissolution conditions, the method aims to enhance cellulose dissolution rates by increasing molecular mobility and reducing cellulose crystallinity. The use of green solvents and optimized dissolution conditions provides an environmentally friendly and efficient process, suitable for industrial-scale applications. The method is applicable to a wide range of cellulose concentrations, including, but not limited to, concentrations ranging from about 5% to about 50% by weight, and is compatible with the use of cost-effective and low-toxicity solvent systems.

Particular embodiments of the disclosure include utilizing optimized conditions for dissolving cellulose in IL and/or DES based dissolution solvent systems, and further incorporating a blend of anionic and/or nonionic surfactants to generate stable cellulose emulsions and/or dispersions. In some embodiments, the nonionic and/or anionic surfactants are added, either separately or in combination, into the cellulose dissolution systems to foster the formation of a stable emulsion of cellulose polymer, dispersing it as colloidal spheres without resorting to Pickering or encapsulated formations.

In another embodiment, the present disclosure includes implementing eco-friendly procedures for extracting and reclaiming solvents from raw cellulosic emulsions/dispersions economically. The process involves extraction, concentration, and purification, aimed at recycling the solvent for cellulose dissolution. This approach not only promotes sustainable solvent recovery with efficiencies >90%, but also curtails the reliance on organic solvents, thus reducing environmental impact. Moreover, reusing the recuperated cellulose dissolution solvents bolsters the circularity of the entire process.

Also disclosed herein are the coalescence properties and film-forming behavior of the resulting cellulosic-derived emulsions and dispersions, which are suitable for use as adhesives and binders. The functionalization of cellulose and its film forming properties were further validated with the solvent recovered cellulosic emulsions and dispersions, including through the incorporation of additives such as bio-based polymers and/or various cellulose crosslinking agents.

Specifically, disclosed and claimed herein is a method of making a composition of matter, the method comprising:
(a) dissolving cellulose in a first solvent to yield a first solution; and then
(b) adding to the first solution an anionic surfactant, a non-ionic surfactant, water, or a combination thereof, in an amount and under conditions sufficient to form a second solution comprising a stable dispersion or emulsion containing cellulose; and then
(c) removing at least a portion of the first solvent to yield a first composition of matter.

In step (a), the first solvent may comprise an ionic liquid or a deep eutectic solvent.

In one version, in step (a) the first solvent comprises a deep eutectic solvent, and the cellulose is dissolved in the first solvent at a concentration ranging from about 1 wt % to about 50 wt %, at a temperature between about 20° C. and about 100° C.

In another version, in step (a) the first solvent comprises an ionic liquid, and the cellulose is dissolved in the first solvent at a concentration ranging from about 1 wt % to about 25 wt %, at a temperature between about 17° C. and about 150° C.

In certain embodiments, in step (b) the anionic surfactant(s), the nonionic surfactant(s), or a mixture of the anionic and nonionic surfactants are added to the first solution at a concentration ranging from about 0.5 wt % to about 5 wt % of the first solution.

In certain embodiments, in step (b), water alone is added in an amount and under conditions sufficient to yield a stable dispersion containing cellulose. In certain embodiments, in step (b), water is added at a concentration ranging from about 0.5 wt % to about 50 wt % of the first solution.

In certain embodiments, in step (c), at least 90 wt % of the first solvent is removed.

The method may further comprise, after step (c), a step (d) of recycling at least a portion of the first solvent removed in step (c). Preferably, at least a portion of the first solvent recycled in step (d) is used as the first solvent in step (a).

In certain embodiments, the cellulosic dispersion or emulsion formed in step (b) has a mean particle size ranging from about 0.1 μm to about 50 μm, as measured by light scattering. In certain embodiments, the first composition of matter formed in step (c) comprises at least 85% cellulose by dry weight.

The method may further comprise mixing the first composition of matter formed in step (c) with at least one bio-based additive to produce a second composition of matter, wherein the bio-based additive comprises one or more of a bio-based polymer, a crosslinking agent, or a combination thereof.

In this approach, the method may further comprise adding water to the first composition of matter formed in step (c) prior to adding the at least one bio-based additive; and agitating the second composition of matter at about 50° C. to about 85° C. for about 1 to about 2 hours.

In certain embodiments, the bio-based additive comprises no more than 45% by dry weight of bio-based polymer, and no more than 15% by dry weight of crosslinking agent. In certain embodiments, the second composition of matter comprises no more than 65% by dry weight of cellulose. In certain embodiments, overall solids content of the second composition of matter ranges from about 15 wt % to about 50 wt %.

The second composition of matter exhibits adhesive strength comparable to commercial adhesive products, characterized by a maximum shear strength in the range of about 1.24 MPa to about 1.68 MPa.

The second composition of matter results in up to 90% reduction in carbon footprint relative to conventional commercially available adhesives and further possesses biodegradability and compostability characteristics.

Also disclosed and claimed herein is a method to form a film, the method comprising step (a) of casting a composition of matter made by the method disclosed herein onto a substrate, whereby a film is formed. The method further comprises after step (a), a step (b) of drying the composition of matter.

In certain embodiments, the film so formed has a tensile strength of from about 1.5 N/m² to about 2.3 N/m². In certain embodiments, the film so formed has an elongation at break value of from about 100% to about 300%.

Also disclosed and claimed herein is a film made by the method described above.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1 depicts optical microscopy images (40× magnification) of cellulose dissolution in deep eutectic solvents (DESs). Panel A: 10% cellulose (w/w) in ZnCl₂/H₂O at room temperature. Panel B: 25% cellulose (w/w) in ZnCl₂/H₂O at 80° C.

FIG. 2 depicts optical microscopy images (40× magnification) of cellulose dissolution in ionic liquids (ILs) Panel A: 2% cellulose (w/w) in [DBNM]DMP at 80° C. Panel B: 5% cellulose (w/w) in ILs at 80° C.

FIG. 3 depicts optical microscopy images of 10% cellulose emulsions/dispersions in a ZnCl₂/H₂O DES dissolution system. Panel A: homogeneous cellulose dispersions by addition of combined approach of surfactants SDS and Nonidet® P-40. Panel B: cellulose in dispersed phase by sequential addition of surfactants: SDS followed by Nonidet® P-40.

FIG. 4 is a process flow diagram depicting removal and recovery of water-miscible IL and DES dissolution system from cellulosic emulsion/dispersions using aqueous phase extraction.

FIG. 5 is a process flow diagram depicting removal and recovery of water-immiscible and/or hydrophobic ionic liquids (HILs) dissolution system from cellulosic emulsion/dispersions using co-solvent addition technique.

FIG. 6 is a bar graph depicting the efficiency of solvent recovery (in %) of ZnCl₂/H₂O DES and superbase IL [DBNM]DMP from cellulosic emulsion/dispersions using aqueous phase extraction technique.

FIG. 7 are optical microscopy images showing homogeneous cellulosic emulsion/dispersion solutions for application as adhesives/binders as produced by mixing the cellulose-enhanced composition of matter with (Panel A) polyvinyl alcohol (PVA), oxalic acid, polyethylene glycol (PEG), hydroxyethyl cellulose (HEC), sodium dodecyl sulfate SDS and polyoxyethylene (20) sorbitan monooleate (“Tween” ® 80-brand); and (Panel B) furan dicarboxylic acid (FDCA), polyethylene glycol PEG, hydroxyethyl cellulose HEC, sodium dodecyl sulfate (SDS) and polyoxyethylene (20) sorbitan monooleate (“Tween” ® 80-brand). (“Tween” ® is a registered trademark of Croda Americas LLC.)

FIG. 8 are optical microscopy images of functionalized cellulosic film obtained after curing of homogeneous cellulosic emulsion/dispersion solutions produced by mixing of cellulose-enhanced composition of matter with: (Panel A) polyvinyl alcohol (PVA), oxalic acid, polyethylene glycol (PEG), sodium dodecyl sulfate (SDS) and polyoxyethylene (20) sorbitan monooleate (“Tween” ® 80-brand); (Panel B) polyvinyl alcohol (PVA), oxalic acid, polyethylene glycol (PEG), carboxymethyl cellulose (CMC), sodium dodecyl sulfate (SDS) and polyoxyethylene (20) sorbitan monooleate; (Panel C) polyvinyl alcohol (PVA), oxalic acid, polyethylene glycol (PEG), hydroxyethyl cellulose (HEC), sodium dodecyl sulfate (SDS) and polyoxyethylene (20) sorbitan monooleate; and (Panel D) FDCA, polyethylene glycol (PEG), hydroxyethyl cellulose (HEC), sodium dodecyl sulfate (SDS) and polyoxyethylene (20) sorbitan monooleate.

FIG. 9 are lap shear strength testing results of the cellulose-based adhesive/binder product Formulation 1 (left panel) and Formulation 2 (right panel).

### DETAILED DESCRIPTION

### Abbreviations and Definitions

ChCl=choline chloride. ChOAc=choline acetate.

The term “contacting” refers to the act of touching, making contact, or of bringing to immediate or close proximity, including at the molecular level, for example, to bring about a chemical reaction, or a physical change, e.g., in a solution or in a reaction mixture.

DES=deep eutectic solvent. A DES is a mixed solvent comprising mixtures of Lewis or Brönsted acids and bases which form a eutectic mixture. (A eutectic mixture is a homogenous mixture whose boiling point is lower than any of the individual constituents in the mixture.) The individual ingredients in deep eutectic solvents engage in a complex hydrogen bonding which also results in significant freezing point depression as compared to the individual ingredients. DESs area broadly classified into four groups based on the ingredients contained in the DES: Type I=quaternary ammonium salt+metal halide. Type II=quaternary ammonium salt+metal halide hydrate. Type III=quaternary ammonium salt+hydrogen bond donor. Type IV=Metal halide hydrate+hydrogen bond donor.

An “effective amount” refers to an amount of a chemical or reagent effective to facilitate a chemical reaction or desired endpoint between two or more components, and/or to bring about a recited effect. Thus, an “effective amount” generally means an amount that provides the desired effect.

FDCA=furan dicarboxylic acid. GlyA=glycolic acid. HBA=hydrogen bond acceptor. HBD=hydrogen bond donor. HEC=hydroxyethyl cellulose. HIL=hydrophobic ionic liquid. IL=ionic liquids. Ionic liquids are salts that are in the liquid state at atmospheric pressures and at a temperature of about 100° C. or less. Im=imidazole. LevA=levulinic acid. PEG=polyethylene glycol. PVA=polyvinyl alcohol. SDS=sodium dodecyl sulfate. SDBS=sodium dodecylbenzene sulfonate.

The term “solvent” refers to any liquid that can dissolve cellulose to form a solution. Solvents include water and a huge number of well-known organic and inorganic solvents.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the disclosed method shall include the corresponding plural characteristic or limitation, and vice-versa, unless otherwise specified or clearly implied to the contrary by the context in which the reference is made. That is, unless specifically stated to the contrary, “a” and “an” mean “one or more.” The phrase “one or more” is readily understood by one of skill in the art, particularly when read in context of its usage. For example, “one or more” substituents on a phenyl ring designates one to five substituents. As used herein, the term “or” is an inclusive “or” operator and is equivalent to the term “and/or” unless the context clearly dictates otherwise.

The elements and method steps described herein can be used in any combination whether explicitly described or not. All combinations of method or process steps as used herein can be performed in any order, unless otherwise specified or clearly implied to the contrary by the context in which the referenced combination is made.

The method disclosed herein can comprise, consist of, or consist essentially of the elements and limitations of the method described herein, as well as any additional or optional steps described herein or otherwise useful in organic chemistry. The disclosure provided herein suitably may be practiced in the absence of any element which is not specifically disclosed herein.

It is understood that the disclosure is not confined to the particular ingredients, compositions of matter, or steps herein illustrated and described, but embraces such modified forms thereof as come within the scope of the claims.

### Overview of the Method

Disclosed herein is a cost-effective and eco-friendly method for creating bio-based emulsion or dispersion compositions primarily made of cellulose from lignocellulosic biomass like trees, grasses, and agricultural residues. The process starts by dissolving cellulose, a renewable and biodegradable polymer, in non-toxic solvents such as one or more ionic liquids (ILs) and/or deep eutectic solvents (DESs). The dissolved cellulose is then combined with anionic and/or nonionic surfactants to form stable emulsions and dispersions, also referred to herein as cellulose-enriched compositions of matter. Optionally, at least a portion of the cellulose dissolution solvents may be reclaimed and recycled into the process (or used elsewhere). The resulting cellulose-enriched compositions of matter may optionally be mixed with additional additives, such as co-polymers for better stability, and/or crosslinking agents for increased durability and eco-friendliness. The resulting cellulose-enriched binders and adhesives are useful to replace petroleum-based materials, promoting environmental sustainability. This approach leverages renewable resources and supports greener industrial practices.

In different versions of the method, a mechanical treatment of cellulose pulps, such as grinding and milling, refining, and mechanical compression, may optionally be implemented before the dissolution stage. Exemplary cellulose pulps include, but are not limited to, northern bleached softwood kraft (NBSK) pulp, eucalyptus pulp, unbleached hemp pulp, non-crosslinked and non-grafted celluloses such as commercially available CF416 (Weyerhaeuser Company, Seattle, Washington), and the like (and combinations thereof). The mechanical processing is aimed to alter the physical properties of the cellulose by increasing its density and reducing its bulk volume. These modifications are helpful because they enhance the surface interaction between the cellulose and the dissolution solvents. By increasing the density and decreasing the bulk volume, the cellulose fibers present a larger surface area for the dissolution solvent system to act upon, which significantly improves the efficiency and uniformity of the dissolution process.

### Dissolving Cellulose in Non-Toxic Solvents

One aspect of the present disclosure is a method for dissolving cellulose from lignocellulosic biomass using non-toxic solvents, including one or more ionic liquids (ILs) and/or deep eutectic solvents (DESs).

In one version, the present disclosure provides a process for the dissolution of cellulose in DES systems. The process involves the preparation of a DES by mixing a hydrogen bond donor (HBD) and a hydrogen bond acceptor (HBA) in specific molar ratios ranging typically (but not necessarily) from about 1:1 to about 1:4 (or as needed) to achieve the desired eutectic point. The cellulose is then introduced into the DES under controlled temperature and agitation conditions, leading to the dissolution of the cellulose. This process can be optimized by adjusting parameters such as the type and ratio of the DES components, temperature, and dissolution time. Suitable combinations of conditions can be elucidated empirically.

According to certain embodiments of the above version, the DES used in the process comprises an HBD and an HBA. Commonly used HBDs include, but are not limited to, urea, ethylene glycol, glycerol, various organic acids, various inorganic acids, polyacids, and combinations thereof. Suitable HBAs include, but are not limited to, choline chloride, choline acetate, betaine, various metal salt hydrates, other quaternary ammonium salts, and combinations thereof.

According to certain embodiments of the above version, cellulose pulp, which may be in the form of powder, fibers, or other suitable forms, is introduced into or otherwise contacted with the prepared DES. The concentration of cellulose in the DES can vary but is generally in the range of about 1% to about 50% by weight. Preferably, the mixture of cellulose and DES is maintained at a temperature between about 20° C. and about 100° C. (Concentrations and temperatures outside these ranges are explicitly within the scope of the disclosed method.) Agitation may be provided using mechanical stirring or high-shear mixing to enhance the dissolution process. The dissolution time preferably varies from a few minutes to several hours, depending on the cellulose type and concentration. Long and short times are explicitly within the scope of the disclosed method. The dissolution process can be optimized by adjusting the molar ratio of HBD to HBA, the temperature, and/or the dissolution time. For example, a higher temperature ranging from about 85° C. to about 100° C. may accelerate the dissolution but may also lead to the degradation of cellulose if not carefully controlled and monitored.

According to certain embodiments of the above version, the DES-based cellulose dissolution solvent system is selected from a group including, but not limited to, ZnCl₂/H₂O, FeCl₃/H₂O, AlCl₃/H₂O, AlCl₃/ZnCl₂/H₂O, AlCl₃/FeCl₃/H₂O, ZnCl₂/FeCl₃/H₂O, ChCl/Urea, ChOAc/GlyA, ChOAc/LevA, ChOAc/Im, ChCl/Urea/H₂O, ChOAc/GlyA/H₂O, ChOAc/LevA/H₂O, ChOAc/Im/H₂O, and combinations thereof, wherein “ChOAc” is choline acetate; “GlyA” is glycolic acid; “LevA” is levulinic acid; and “Im” is imidazole.

In another version, the present disclosure provides a process for dissolving cellulose in ILs as dissolution systems, which are liquid-state salts with low melting points, high thermal stability, and negligible vapor pressure, effectively disrupting the hydrogen bonding network of cellulose. Suitable ILs are selected for their cellulose-dissolving capabilities and low toxicity. The process involves preparing an IL solution, contacting the solution with cellulose, and optionally heating and stirring the mixture to achieve a homogeneous solution.

In certain embodiments of the above version, the IL-based cellulose dissolution solvent system comprises one or more ionic liquids selected based on their favorable properties and chemical structures. Suitable examples include, but are not limited to: [DBNM]DMP (1-methyl-1,5-diazabicyclo[4.3.0]-non-5-enium dimethylphosphate), [DBNE]DEP (1-ethyl-1,5-diazabicyclo[4.3.0]non-5-enium diethylphosphate), [DBUM]DMP (1-methyl-1,8-diazabicyclo[5.4.0]undec-7-enium dimethylphosphate), [DBUE]DEP (1-ethyl-1,8-diazabicyclo[5.4.0]undec-7-enium diethylphosphate), [Emim]OAc (1-Ethyl-3-methylimidazolium acetate), [HOOC₄mim]Cl (1-(3-Carboxypropyl)-3-methylimidazolium chloride), [MTBDH]OAc (7-Methyl-1,5,7-triazabicyclo[4.4.0]dec-5-enium acetate), [MTBNH]OAc (5-Methyl-1,5,7-triazabicyclo[4.3.0]non-6-enium acetate), and combinations thereof.

According to certain embodiments of the above version, cellulose pulp in the form of powder, fibers, or other suitable forms is introduced into prepared ILs at a concentration ranging from about 1% to about 25% by weight. The dissolution process can be enhanced by adding co-solvents such as dimethyl sulfoxide (DMSO), N,N-dimethylformamide (DMF), acetone, methanol, ethanol, tetrahydrofuran (THF), water (H₂O), and combinations thereof. Fine-tuning the ratio of these co-solvents improves solubility and reduces the viscosity of the IL-cellulose solution, significantly enhancing the dissolution rate. The mixture is preferably maintained at about 17° C. to about 150° C. and agitated using mechanical stirring or high-shear mixing. Dissolution time varies from a few minutes to several hours, depending on the cellulose type and concentration. (Cellulose concentrations, temperatures, and dissolution times outside the ranges described above are explicitly within the scope of the disclosed method.) Optimization of the dissolution process in ILs involves adjusting the molar ratio of co-solvents, temperature, and dissolution time.

In different versions of the method, the cellulose dissolution solvent system (ILs and/or DESs) can dissolve at least 1%, at least 2%, at least 3%, at least 5%, at least 10%, at least 15%, at least 20%, at least 25%, at least 30%, at least 35%, at least 40%, at least 45%, or at least 50% of cellulose by weight.

In other variations of the method, the method is configured to produce a range of dissolved cellulose particles with molecular weights varying from about 10% to about 100% of the original molecular weight of the undissolved cellulose. This is achieved by precisely controlling dissolution conditions, which include factors such as the choice of dissolution solvent systems, the type and concentration of co-solvents, temperature, agitation method, and dissolution time. Such control enables targeted reductions in molecular weight while preserving key properties of cellulose, resulting in particles that are more manageable and readily processed within the dissolution solvent system.

Creating Stable Cellulosic Emulsions and/or Dispersions

Another aspect of the present disclosure is a method for creating stable cellulosic emulsions and/or dispersions. This method utilizes anionic surfactants, nonionic surfactants, water, or a combination thereof, strategically integrated into the cellulose dissolution system. In this method, cellulose polymers are organized into a dispersed phase, resulting in colloidal emulsions of spherical particles. Critically, this process circumvents the formation of Pickering emulsions or encapsulated structures, thereby enhancing the stability and integrity of the resultant cellulose-based formulations.

Exemplary nonionic surfactants suitable for use in the method include, but are not limited to, polyoxyethylene sorbitan monooleates (available commercially under the “Tween” ® brand) and octylphenoxypolyethoxyethanols (available commercially under the “Nonidet” ®-brand, such as “Nonidet” ® P-40 [Evonic Operations GMBH, Essen, Germany], and “IGEPAL” ® CA-630, available from Sigma-Aldrich, St. Louis, Missouri, USA. “IGEPAL” is a registered trademark of Rhodia Operations, Aubervilliers, France), and the like. Examples of anionic surfactants suitable for use in the method include, but are not limited to, sodium dodecyl sulfate (SDS), sodium dodecylbenzene sulfonate (SDBS), and the like. These surfactants are used to generate stable cellulosic emulsions or dispersions. The surfactants can be added individually or in combinations to the cellulose dissolution systems.

In some variations of the method, the surfactants may be introduced as aqueous solutions with concentrations ranging from about 1% to about 10% w/w, or in their pure form. The surfactants may be directly added to the dissolved cellulose in the dissolution systems, optionally with continuous mixing to promote thorough integration. In certain embodiments, the final concentration of surfactants during the emulsification process is maintained between about 0.5% to about 5% w/w. This method facilitates the formation of stable emulsions and/or dispersions, effectively preventing the cellulose polymers from aggregation or encapsulation.

The mean particle size of the resulting cellulosic emulsions and/or dispersions is estimated to be in the range of from about 0.1 μm to about 50 μm as measure by light scattering, with high stability against drop coalescence and a shelf-life of at least about three (3) months under room temperature conditions.

### Extracting and Recovering Dissolution Solvents

Another aspect of the present disclosure involves a cost-effective method for extracting and recovering dissolution solvents from crude cellulosic emulsions and dispersions to obtain a first composition of matter. Throughout the disclosure, the “first composition of matter” is also referred to as a “cellulose-enriched compositions of matter” or a “solvent recovered cellulose emulsions/dispersion.”

This method takes advantage of the natural miscibility of dissolution solvent systems, such as ILs and DESs, with non-toxic green solvents, including, but not limited to, water, supercritical carbon dioxide (scCO₂), glycerol, methanol, ethanol, ethyl lactate, and limonene. By using non-toxic green solvents for extraction, ILs and DESs transition into the extracting solvent phase, enabling their separation from the stable cellulosic emulsions and dispersions. This enhances the efficiency of both the extraction and solvent recovery processes, allowing for reusability. Optimal extraction and recovery of ILs and DESs using non-toxic green solvents may be achieved by empirically adjusting operational parameters, including temperature, pressure, and extraction time.

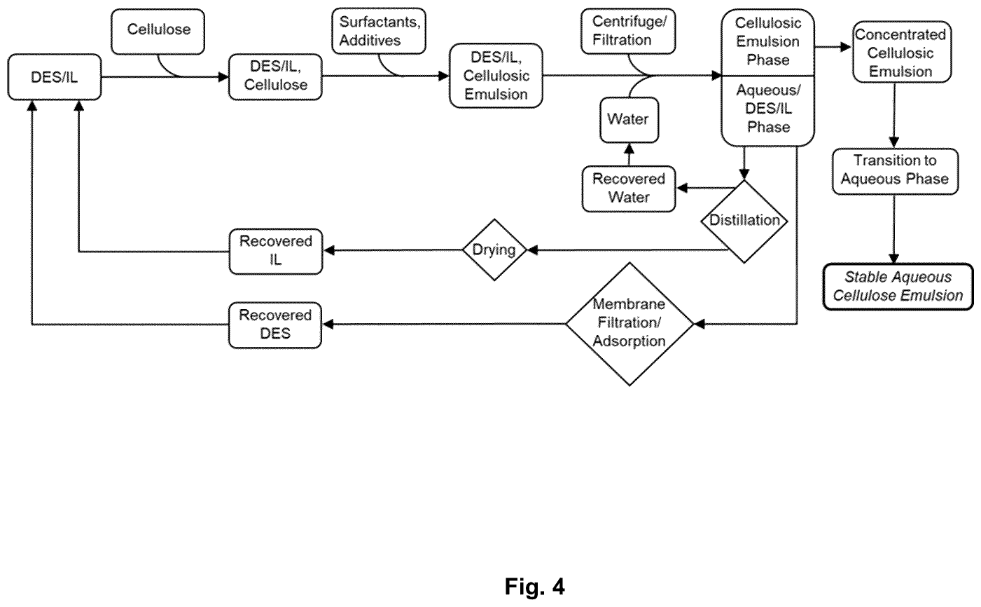

In one version of the method, aqueous-based processing techniques are employed to efficiently recover ionic liquids (ILs) and deep eutectic solvents (DESs) from cellulosic emulsions and dispersions. This recovery method may include, individually or in combination, distillation, membrane filtration, and adsorption. Distillation leverages the different boiling points of water and ILs to achieve separation. Membrane filtration uses specialized membranes to selectively filter out DESs (salts). Adsorption techniques employing materials like activated carbon or zeolites are utilized to selectively capture and recover DESs. See FIG. 4.

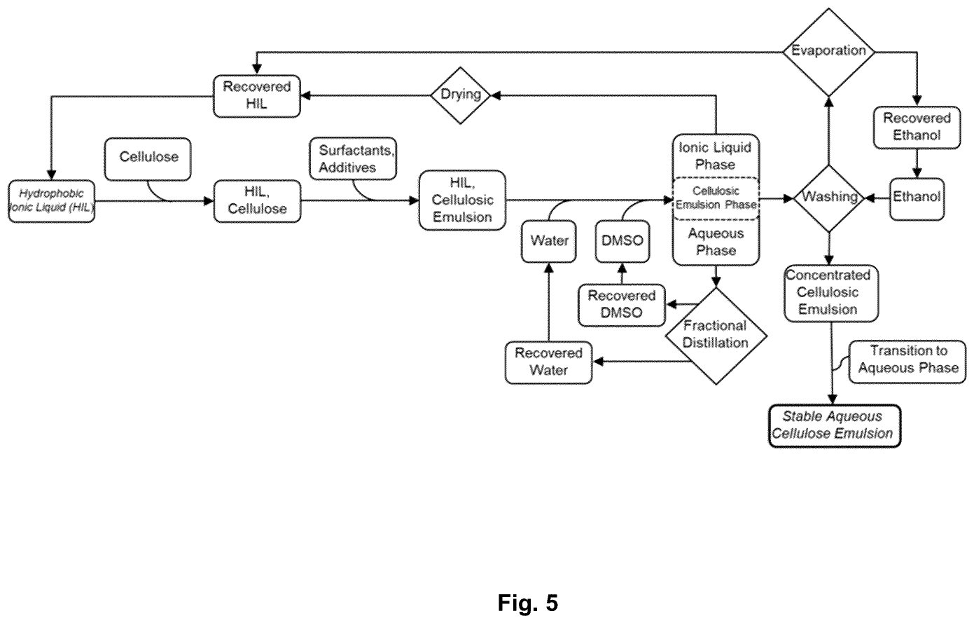

In another version of the method, an alternative solvent recovery process is provided for efficiently isolating and recovering water-immiscible and/or hydrophobic ionic liquids (HILs) used in dissolving systems for generating stable cellulose emulsions and dispersions. See FIG. 5. This method introduces dimethyl sulfoxide (DMSO) as a co-solvent and uses water as an anti-solvent in the HIL-cellulose emulsion mixture. In this process, the addition of water induces precipitation of the cellulose emulsions/dispersions, causing DMSO to enter the aqueous phase, resulting in a biphasic liquid system (aqueous and HIL) and a solid phase (cellulosic emulsion/dispersion). Solid/liquid separation may be performed by centrifugation or filtration. The hydrophobic HIL phase separates from the aqueous phase in the supernatant, and can be collected. Any residual HILs associated with the solid cellulosic material may be further washed and extracted by adding ethanol. The ethanol phase is then evaporated, and the recovered HIL is combined with the initially recovered HIL phase to improve overall recovery efficiency.

In various versions of the method, at least 50%, at least 55%, at least 60%, at least 65%, at least 70%, at least 75%, at least 80%, at least 85%, at least 90%, at least 95%, at least 96%, at least 97%, at least 98% or at least 99% of the dissolution solvent system including, but not limited to, ILs, DESs, and HILs, may be recovered from the stable cellulosic emulsions and dispersions to yield a first composition of matter comprising cellulose.

In certain embodiments, the cellulose-containing first composition of matter produced by the method comprises >85% cellulose by dry weight. Preferably, the cellulose-containing composition of matter produced by the method comprises at least 50%, at least 55%, at least 60%, at least 65%, at least 70%, at least 75%, at least 80%, at least 85%, at least 90%, at least 95% or at least 96% by dry weight cellulose.

### Producing Bio-Based Adhesives and Binders

Also disclosed herein is a method for producing bio-based adhesives and binders through the blending and/or mixing of solvent-recovered cellulosic emulsions or dispersions with various additives. This process involves incorporating bio-based polymers and/or bio-based crosslinking agents to create a second composition of matter specifically designed for adhesive and binder applications. Throughout the disclosure, the “second composition of matter” is also referred to as a “cellulose-enriched binder and adhesive,” a “cellulosic based adhesive/binder composition of matter,” or a “bio-based adhesive/binder composition.” The use of bio-based polymers and crosslinking agents not only enhances the performance of the adhesives but also promotes sustainability by utilizing renewable resources, offering an environmentally friendly alternative to traditional synthetic adhesives and binders.

Exemplary bio-based crosslinking agents suitable for use in this method include, but are not limited to, oxalic acid, succinic acid, levulinic acid, lactic acid, furan dicarboxylic acid (FDCA), and polyvinyl alcohol (PVA), and the like, and combinations thereof. These agents are chosen for their ability to effectively crosslink with cellulosic materials, thereby enhancing the adhesive properties of the final composition. Similarly, the bio-based polymers suitable for use in this method include, but are not limited to, carboxymethyl cellulose (CMC), polyvinyl alcohol (PVA), polylactic acid (PLA), hydroxyethyl cellulose (HEC) and the like, and combinations thereof. These polymers are selected for their compatibility with cellulosic materials and their ability to form strong, durable adhesive bonds.

In certain preferred versions of the method, in addition to bio-based polymers and crosslinking agent, softening agents may also be incorporated as additional adhesive/binder components. Suitable softening agents include, but are not limited to, polyoxyethylene sorbitan monooleates, octylphenoxypolyethoxyethanols, SDS, SDBS, glycerol, ethylene glycol, polyethylene glycol (PEG), and the like, and combination thereof.

In certain versions, the method may further include the addition of other functional additives, such as plasticizers, rheology modifiers, and surfactants, among others.

In certain versions of the method, water is introduced into solvent recovered cellulose emulsions/dispersions, followed by agitation and/or high shear mixing at room temperature and/or at elevated temperature for 1 to 10 minutes. Subsequently, predetermined quantities of bio-based polymers and/or crosslinking agents are incorporated, optionally followed by the addition of softening agents. The resulting mixture was then agitated at 50° C. to 85° C. for 1 hour to 2 hours, yielding a diverse array of aqueous-based homogeneous cellulosic based adhesive/binder composition of matter, i.e., the second composition of matter.

Preferably, in the second composition of matter, the cellulose is present such that at least 90.0% by weight of the total celluloses content in the composition are in a water insoluble emulsion and/or dispersion form, i.e. present as cellulose polymer in a dispersed phase. More preferably, at least 91.0%, at least 92.0%, at least 93.0%, at least 94.0%, at least 95.0%, at least 96.0%, at least 97.0%, at least 98.0%, at least 99.0%, and most preferably at least 99.9% by weight of the cellulose is present as water insoluble emulsions or dispersions.

In various versions of the method, the adhesive components (i.e., the additives) of the total bio-based adhesive/binder composition may include at least 1%, at least 2%, at least 5%, at least 10%, at least 15%, at least 20%, at least 25%, at least 30%, at least 35%, at least 40% or at least 45% by dry weight of a bio-based polymer, and crosslinking agents in an amount ranging from about 1% to about 15% by dry weight. In particular embodiments, the crosslinking agent content is at least 1%, at least 2%, at least 3%, at least 4%, at least 5%, at least 6%, at least 7%, at least 8%, at least 9%, at least 10% at least 11%, at least 12%, at least 13%, at least 14% or at least 15% by dry weight of the bio-based adhesive components.

In other variations of the method, the adhesive components of the total bio-based adhesive/binder composition may include >0.25% of softening agent by dry weight. It is preferred that the softening agent is present at a concentration of at least 0.25%, at least 0.50%, at least 0.75%, at least 1.00%, at least 1.25%, at least 1.50%, at least 1.75%, at least 2.00%, at least 2.25%, at least 2.50%, at least 2.75%, at least 3.00%, at least 3.25%, at least 3.50%, at least 3.75%, at least 4.00%, at least 4.25%, at least 4.50%, at least 4.75%, or at least 5.00% by dry weight of the bio-based adhesive components.

The bio-based adhesive/binder composition of matter according to the present disclosure comprises a cellulose emulsion/dispersion in an amount ranging from about 25% to about 65% by dry weight (wt), based on the total weight of the adhesive/binder composition. In certain preferred embodiments, the cellulose content is at least 30% wt, more preferably at least 35% wt, even more preferably at least 40% wt, yet more preferably at least 45% wt, more preferably at least 50% wt, even more preferably at least 55% wt, more preferably at least 60% wt, yet more preferably at least 65% wt, and even more preferably at least 66% wt.

The bio-based adhesive/binder composition of matter disclosed herein is characterized by its environmentally beneficial properties, including inherent biodegradability and compostability. Furthermore, the composition contributes to a substantial reduction in environmental impact, with an estimated carbon footprint reduction of up to 90% compared to conventional petroleum-based or synthetic adhesives currently available in the commercial marketplace. This significant reduction in carbon emissions is attributable to the renewable origin of the constituent materials and the reduced energy requirements associated with its production and lifecycle.

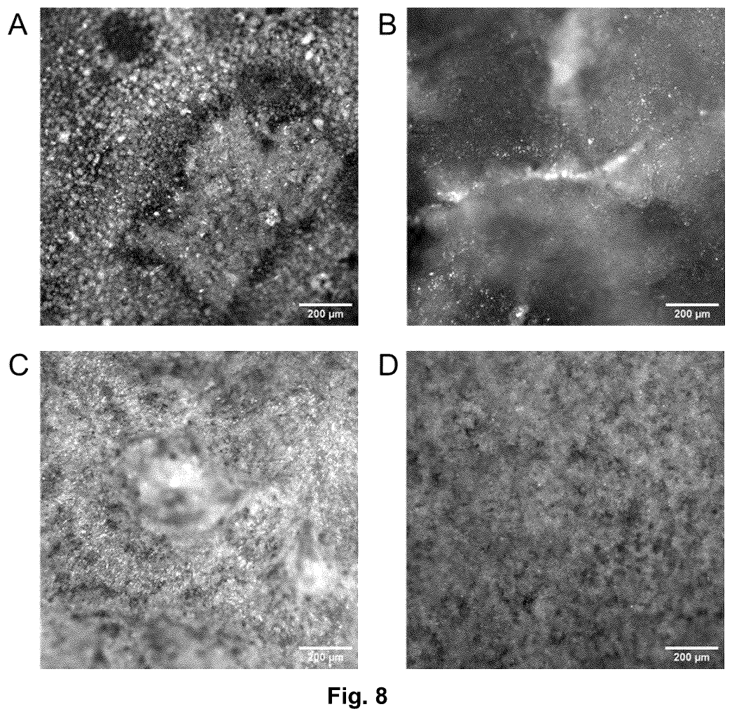

The present disclosure further addresses the curing and coalescence properties of the bio-based formulations in the second composition of matter. These formulations undergo a curing process that facilitates coalescence, resulting in the successful formation of continuous films. See FIG. 8. The outcome is a cohesive and homogeneous layer of functionalized cellulosic films. Extensive testing has demonstrated that the tensile strength and elongation at break values of these bio-based films are comparable to those of conventional acrylic emulsions. This similarity in mechanical properties highlights the potential of these formulations for diverse applications. Notably, they can be effectively used as binders and adhesives, offering an environmentally friendly alternative to traditional synthetic materials. The resulting functionalized cellulosic films exhibit robustness and flexibility, making them suitable for various industrial and commercial uses, further broadening their application scope.

### EXAMPLES

The following examples serve to further illustrate various embodiments of the disclosure. Throughout the application, illustrative guidance is provided through lists of examples, which may be used in various combinations. These lists are intended to be representative and should not be interpreted as an exclusive list.

### Example 1

### Cellulose Dissolution in Deep Eutectic Solvents

This example describes the dissolution of cellulose in deep eutectic solvent (DES) systems. The resulting cellulose solution obtained from this dissolution process can be utilized in the formulation of cellulose-based emulsions and dispersions compositions.

Materials and Methods: In a typical experimental procedure for a 10 g solution sample, a specific mass of cellulose pulp (% w/w as listed in Table 1) was placed into a 50 mL beaker containing a stir bar. Metal salt hydrate-based DES was then added to make a total sample mass of 10.0 g, and the mixture was stirred at a specific temperature shown in Table 1 until dissolution was observed. The mixing time taken for dissolution was then recorded.

TABLE 1
Experimental conditions of dissolution
of cellulose in DES solvent systems.

| | | | | Cellulose |
|---|---|---|---|---|
| | | Mixing | Temper- | Dissolu- |
| | | Time | ature | tion |
| Cellulose Type | Dissolution System | (h) | (° C.) | (% w/w) |
| NBSK | ZnCl₂/H₂O | 18-84 | 22 | 5-15 |
| NBSK | ZnCl₂/H₂O | 0.5-1.5 | 60-100 | 15-30 |
| NBSK | AlCl₃/ZnCl₂/H₂O | 18-84 | 22 | 5-15 |
| NBSK | AlCl₃/ZnCl₂/H₂O | 0.5-1.5 | 60-100 | 15-20 |
| NBSK | FeCl₃/H₂O | 0.5-1.5 | 80-100 | 2-5 |
| NBSK | ChCl/Urea/H₂O | 1-4 | 60-100 | 2 |
| NBSK | ChOAc/GlyA/H₂O | 0.5-2.0 | 60-100 | 5-15 |
| NBSK | ChOAc/LevA/H₂O | 0.5-2.0 | 60-100 | 5-15 |
| NBSK | ChOAc/Im/H₂O | 0.5-2.0 | 60-100 | 5-15 |
| Dissolving Pulp | ZnCl₂/H₂O | 24-48 | 22 | 5-10 |
| Dissolving Pulp | ZnCl₂/H₂O | 0.5-1.5 | 35-100 | 15-20 |
| Dissolving Pulp | AlCl₃/ZnCl₂/H₂O | 24-48 | 22 | 5-10 |
| Dissolving Pulp | AlCl₃/ZnCl₂/H₂O | 0.5-1.5 | 60-100 | 15-20 |
| Dissolving Pulp | FeCl₃/H₂O | 0.5-1.5 | 80-100 | 2-5 |
| Dissolving Pulp | ChCl/Urea/H₂O | 1-4 | 60-100 | 2 |
| Dissolving Pulp | ChOAc/GlyA/H₂O | 0.5-2.0 | 60-100 | 5-15 |
| Dissolving Pulp | ChOAc/LevA/H₂O | 0.5-2.0 | 60-100 | 5-15 |
| Dissolving Pulp | ChOAc/Im/H₂O | 0.5-2.0 | 60-100 | 5-15 |
| Eucalyptus Pulp | ZnCl₂/H₂O | 40-108 | 22 | 5-15 |
| Eucalyptus Pulp | ZnCl₂/H₂O | 1-2 | 80-100 | 15-20 |
| Eucalyptus Pulp | AlCl₃/ZnCl₂/H₂O | 40-108 | 22 | 5-15 |
| Eucalyptus Pulp | AlCl₃/ZnCl₂/H₂O | 1-2 | 80-100 | 15-20 |
| Eucalyptus Pulp | FeCl₃/H₂O | 0.5-2.0 | 80-100 | 2-5 |
| Eucalyptus Pulp | ChCl/Urea/H₂O | 1-4 | 60-100 | 2 |
| Eucalyptus Pulp | ChOAc/GlyA/H₂O | 0.5-2.0 | 60-100 | 5-15 |
| Eucalyptus Pulp | ChOAc/LevA/H₂O | 0.5-2.0 | 60-100 | 5-15 |
| Eucalyptus Pulp | ChOAc/Im/H₂O | 0.5-2.0 | 60-100 | 5-15 |

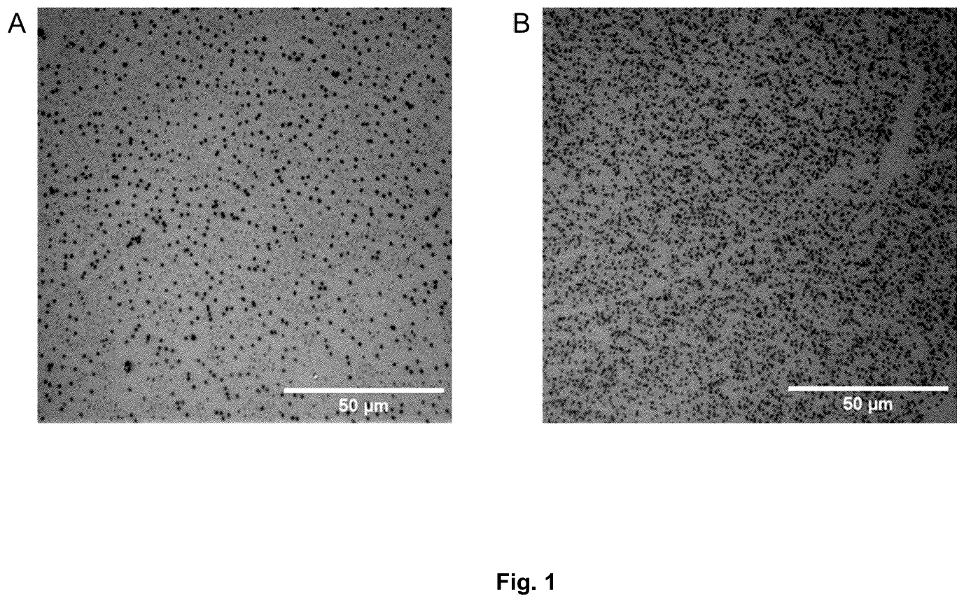

Results: Dissolution of up to 15% w/w cellulose concentration was achieved in the ZnCl₂/H₂O system at room temperature (22° C.) for NBSK and eucalyptus pulp while up to 10% w/w dissolving pulp was solubilized under the same conditions. With added heat, the soluble concentrations increased by at least 5% w/w, with NBSK reaching the highest amount at 30% w/w. In contrast, the FeCl₃/H₂O system needed 80° C. heat to dissolve 5% w/w of NBSK. Optical microscopy was used to further observe the dissolution samples (see FIG. 1).

### Example 2

### Cellulose Dissolution in Ionic Liquids

This example illustrates the process of dissolving cellulose in ionic liquid (IL) systems. This dissolved cellulose solution can also be used for making cellulosic based emulsion and/or dispersion composition.

Materials and Methods: In a typical experimental procedure for a 10 g solution sample, a specific mass of cellulose (% w/w as listed in Table 2) was placed into a 50 mL beaker containing a stir bar. Ionic liquid was then added to make a total sample mass of 10.0 g, and the mixture was stirred at 80° C. for the specified time shown in Table 2 to complete dissolution.

TABLE 2
Experimental conditions of dissolution
of cellulose in ILs solvent systems.

| | | Mixing | Temper- | Cellulose |
|---|---|---|---|---|
| | Dissolution | Time | ature | Dissolution |
| Cellulose Type | System | (h) | (° C.) | (% w/w) |
| NBSK | [DBNM]DMP | 1-4 | 80-100 | 2 |
| NBSK | [DBNE]DEP | 1-4 | 80-100 | 2 |
| NBSK | [DBNM]DMP | 8-24 | 80-100 | 5 |
| NBSK | [DBNE]DEP | 8-24 | 80-100 | 5 |
| NBSK | [DBUM]DMP | 1-4 | 80-100 | 2 |
| NBSK | [DBUE]DEP | 1-4 | 80-100 | 2 |
| NBSK | [DBUM]DMP | 8-24 | 80-100 | 5 |
| NBSK | [DBUE]DEP | 8-24 | 80-100 | 5 |
| NBSK | [Emim]OAc | 1-24 | 80-100 | 2-5 |
| NBSK | [Emim]DEP | 1-24 | 80-100 | 2-5 |
| NBSK | [HOOC₄mim]Cl | 3-24 | 25-100 | 2-5 |
| NBSK | [MTBDH]OAc | 2-24 | 80-100 | 2-5 |
| NBSK | [MTBNH]OAc | 2-24 | 80-100 | 2-5 |
| Dissolving Pulp | [DBNM]DMP | 1-4 | 80-100 | 2 |
| Dissolving Pulp | [DBNE]DEP | 1-4 | 80-100 | 2 |
| Dissolving Pulp | [DBNM]DMP | 8-24 | 80-100 | 5 |
| Dissolving Pulp | [DBNE]DEP | 8-24 | 80-100 | 5 |
| Dissolving Pulp | [DBUM]DMP | 1-4 | 80-100 | 2 |
| Dissolving Pulp | [DBUE]DEP | 1-4 | 80-100 | 2 |
| Dissolving Pulp | [DBUM]DMP | 8-24 | 80-100 | 5 |
| Dissolving Pulp | [DBUE]DEP | 8-24 | 80-100 | 5 |
| Dissolving Pulp | [Emim]OAc | 1-24 | 80-100 | 2-5 |
| Dissolving Pulp | [Emim]DEP | 1-24 | 80-100 | 2-5 |
| Dissolving Pulp | [HOOC₄mim]Cl | 3-24 | 25-100 | 2-5 |
| Dissolving Pulp | [MTBDH]OAc | 2-24 | 80-100 | 2-5 |
| Dissolving Pulp | [MTBNH]OAc | 2-24 | 80-100 | 2-5 |
| Dissolving Pulp | [DBNM]DMP | 1-4 | 80-100 | 2 |
| Eucalyptus Pulp | [DBNE]DEP | 1-4 | 80-100 | 2 |
| Eucalyptus Pulp | [DBNM]DMP | 8-24 | 80-100 | 5 |
| Eucalyptus Pulp | [DBNE]DEP | 8-24 | 80-100 | 5 |
| Eucalyptus Pulp | [DBUM]DMP | 1-4 | 80-100 | 2 |
| Eucalyptus Pulp | [DBUE]DEP | 1-4 | 80-100 | 2 |
| Eucalyptus Pulp | [DBUM]DMP | 8-24 | 80-100 | 5 |
| Eucalyptus Pulp | [DBUE]DEP | 8-24 | 80-100 | 5 |
| Eucalyptus Pulp | [Emim]OAc | 1-24 | 80-100 | 2-5 |
| Eucalyptus Pulp | [Emim]DEP | 1-24 | 80-100 | 2-5 |
| Eucalyptus Pulp | [HOOC₄mim]Cl | 3-24 | 25-100 | 2-5 |
| Eucalyptus Pulp | [MTBDH]OAc | 2-24 | 80-100 | 2-5 |
| Eucalyptus Pulp | [MTBNH]OAc | 2-24 | 80-100 | 2-5 |
| Unbleached Pulp | [DBNM]DMP | 8-24 | 80-100 | 2 |
| Unbleached Pulp | [DBNE]DEP | 8-24 | 80-100 | 2 |
| Unbleached Pulp | [DBUM]DMP | 8-24 | 80-100 | 2 |
| Unbleached Pulp | [DBUE]DEP | 8-24 | 80-100 | 2 |
| Unbleached Pulp | [Emim]OAc | 8-24 | 80-100 | 2 |
| Unbleached Pulp | [Emim]DEP | 8-24 | 80-100 | 2 |
| Unbleached Pulp | [HOOC₄mim]Cl | 8-24 | 80-100 | 2 |
| Unbleached Pulp | [MTBDH]OAc | 8-24 | 80-100 | 2 |
| Unbleached Pulp | [MTBNH]OAc | 8-24 | 80-100 | 2 |

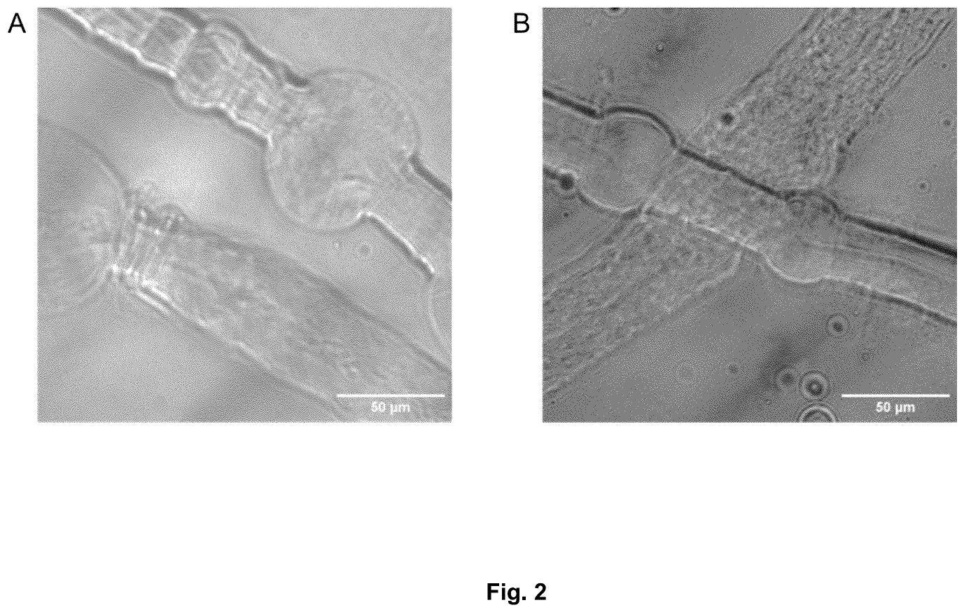

Results: Dissolution of 2% w/w cellulose concentration was achieved in ILs for all tested cellulose types at 80° C. while up to 5% w/w was solubilized with an extended mixing time of up to 24 hours. Optical microscopy was used to further observe the dissolution samples. Microscopy images for NBSK and dissolving pulp in the superbase-derived [DBNM]DMP ionic liquid showed long, swollen strands, suggesting that the cellulose in solution has a larger structure and molecular weight than all previous samples in the DES solvent systems (See FIG. 2).

### Example 3

### Production of Cellulose Emulsion and Dispersion with Single Surfactant

This example describes the preparation of a cellulosic emulsion/dispersion using a single surfactant.

Materials and methods: In a typical experimental procedure, a specific amount of a 1% w/w stock aqueous solution of surfactant was added in portions of several mL to a 50 mL beaker containing a 10 g solution of NBSK cellulose dissolved in DES as listed in Table 3. The mixture was then stirred for 2 hours at the specified temperature shown in Table 3.

TABLE 3
Experimental conditions for production of cellulose emulsion/dispersion
with addition of single surfactants.

| | | | | | Mixing | |
|---|---|---|---|---|---|---|
| Cellulose | Dissolution | % w/w | Surfactant | % w/w | Time | Temperature |
| Type | System | Cellulose | Type | Surfactant | (h) | (° C.) |
| NBSK | ZnCl₂/H₂O | 10 | SDS | 0.50 | 2 | 22 |
| NBSK | ZnCl₂/H₂O | 10 | Tween ® 80 | 0.50 | 2 | 22 |
| NBSK | ZnCl₂/H₂O | 10 | Nonidet ® | 0.50 | 2 | 22 |
| | | | P-40 | | | |
| NBSK | ZnCl₂/H₂O | 10 | SDBS | 0.50 | 2 | 22 |
| NBSK | FeCl₃/H₂O | 5 | SDS | 0.50 | 2 | 80 |
| NBSK | FeCl₃/H₂O | 5 | Tween ® 80 | 0.50 | 2 | 80 |
| NBSK | FeCl₃/H₂O | 5 | Nonidet ® | 0.50 | 2 | 80 |
| | | | P-40 | | | |
| NBSK | FeCl₃/H₂O | 5 | SDBS | 0.50 | 2 | 80 |

Results: Optical microscopy was used to observe the mixtures. Images for samples in ZnCl₂/H₂O showed a more even dispersion while those in FeCl₃/H₂O showed a portion of dissolved cellulose in partial fibers form.

### Example 4

### Cellulose Emulsion/Dispersion with Combined Surfactants

This example describes the preparation of a cellulosic emulsion/dispersion using a combination of one anionic surfactant (SDS) and one nonionic surfactant, (polyoxyethylene sorbitan monooleate [“Tween” ® 80-brand] or octylphenoxypolyethoxyethanol [“Nonidet” ® P-40-brand]).

Materials and methods: In a typical experimental procedure, stock aqueous solutions of 1% w/w of two surfactants were added in portions to a 50 mL beaker containing a 10 g solution of dissolved NBSK cellulose to achieve the final surfactant concentrations listed in Table 4. The mixture was then stirred for 2 to 3 hours at room temperature. In an alternative approach, the combination of surfactants was added sequentially to the dissolution systems with one in pure form and the other as a 5% w/w aqueous solution to achieve final surfactant concentrations of 0.25% w/w each in the final mixture. After adding the first surfactant in pure form to the dissolved cellulose sample, the solution was mixed at room temperature using an IKA T25 Easy Clean Control ULTRA-TURRAX dispersing instrument with the mixing speed set at 7000 rpm for 3 minutes (IKA Works, Inc., Wilmington, NC, USA). Then sequential addition of the second surfactant from an aqueous stock solution (5% w/w stock solution) was added, followed by high shear mixing at 15000 rpm for 10 minutes.

TABLE 4
Experimental conditions for production of cellulose emulsion/dispersion
with addition of both anionic and non-ionic surfactants.

| | | | | % w/w | % w/w | Mixing | |
|---|---|---|---|---|---|---|---|
| Cellulose | Dissolution | % w/w | % w/w | “Tween” ® | “Nonidet” ® | Time | Temp |
| Type | System | Cellulose | SDS | 80 | P-40 | (h) | (° C.) |
| NBSK | ZnCl₂/H₂O | 10 | 0.25 | 0.25 | 0 | 0.5-3 | 22 |
| NBSK | ZnCl₂/H₂O | 10 | 0.25 | 0 | 0.25 | 0.5-3 | 22 |
| NBSK | FeCl₃/H₂O | 5 | 0.25 | 0.25 | 0 | 2-3 | 22 |
| NBSK | FeCl₃/H₂O | 5 | 0.25 | 0 | 0.25 | 2-3 | 22 |
| NBSK | [DBNM]DMP | 2 | 0.20 | 0 | 0.20 | 0.5 | 22 |

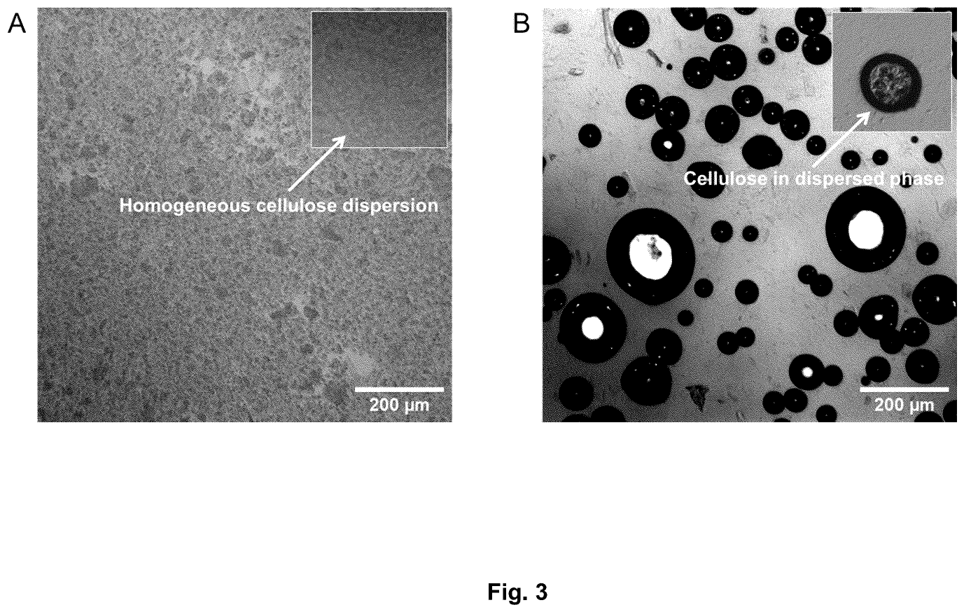

Results: Optical microscopy was used to study the resulting mixtures. Similarly to the experiments with single surfactants, the samples in ZnCl₂/H₂O were more evenly dispersed than those in FeCl₃/H₂O. Additionally, the combined addition of two surfactants generally resulted in a homogeneous cellulose dispersion while the sequential addition of SDS followed by “Nonidet” ® P-40-brand surfactant showed the highest amount of emulsion formation with cellulose in the dispersed phase (see FIG. 3).

### Example 5

### Solvent Removal and Recovery

This example describes the process to recover the deep eutectic solvents and ionic liquids from the emulsions by separating these solvents from water.

Materials and methods: In the general case of water-miscible DES and IL solvents, distillation was used to separate the ILs while membrane filtration and adsorption was used to capture the DESs (see FIG. 4). Alternatively, for water-immiscible and/or hydrophobic ILs, DMSO was introduced as a co-solvent to help separate the IL from both the cellulosic emulsion and water phases (see FIG. 5). This process was conducted by introducing varying volumes of water, ranging from 1 to 5 times the volume of the initial dissolution solvent system. The strategic manipulation of water volumes allowed for precise control over the solvent extraction dynamics and facilitated the efficient transition of the zinc-based DES and water-miscible superbase-derived ILs into the aqueous phase.

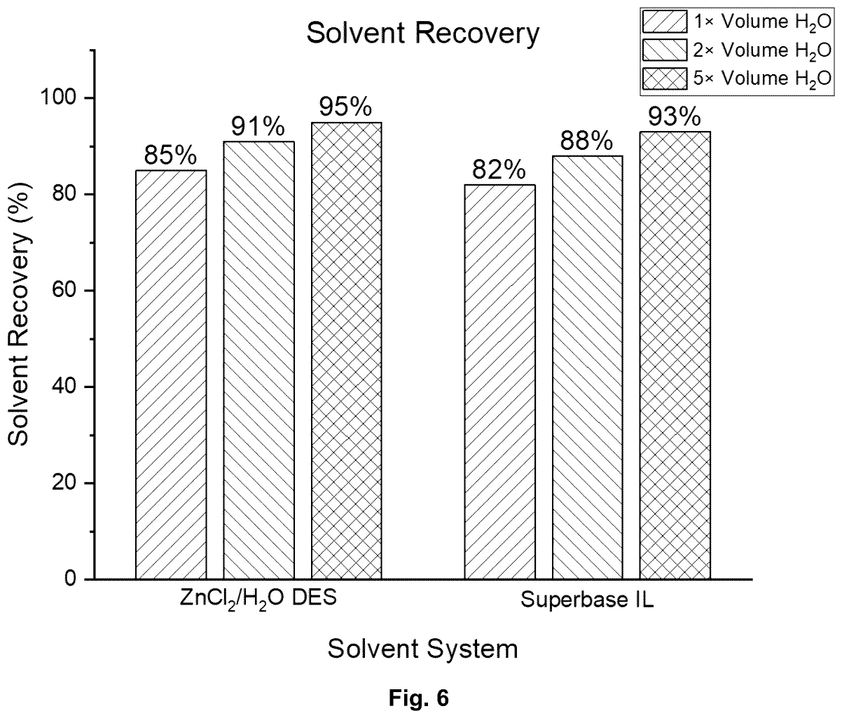

Results: The cellulose emulsion underwent a controlled and effective transformation, precipitating out as it seamlessly transitioned into an aqueous medium, adopting a stable emulsion and/or dispersion configuration. This process resulted in a well-defined and homogeneous dispersion of cellulose in the aqueous phase. Solvent recovery yields were in the range of 85-95% for the ZnCl₂/H₂O DES and 82-93% for the superbase [DBNM]DMP IL (see FIG. 6).

### Example 6

### Cellulosic-Based Adhesives and Binders: Product Formulation Using Cellulose Emulsion/Dispersion with Additives and Crosslinkers

This example describes the preparation of product formulations with solvent recovered cellulose emulsions/dispersions and various additives to demonstrate adhesive/binder as well as coalescence properties.

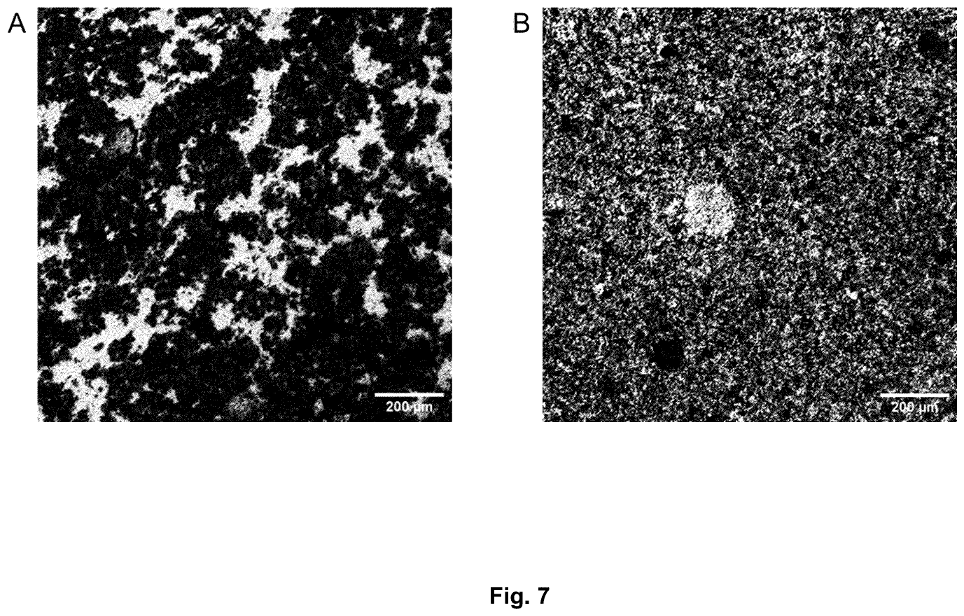

Materials and methods: While preparing each sample, deionized water was introduced into solvent recovered cellulose emulsions/dispersions, followed by stirring at room temperature for 3 minutes. Subsequently, predetermined quantities of additives were incorporated, with surfactants being the final addition from aqueous stock solutions. The resulting mixture was then stirred at 85° C. for 1.25 to 1.75 hours, yielding a diverse array of aqueous-based homogeneous cellulosic formulations as observed by optical microscopy (see FIG. 7). These formulations were created to assess coalescence properties and film-forming behavior. Subsequently, 2-4 g portions of each heated mixture were dispensed into Petri dishes and gradually dried using a heat gun for 10-60 minutes, followed by overnight air drying.

TABLE 5
Bio-based adhesive/binder product formulations with cellulose emulsions/dispersions
by combination of various additives and crosslinkers.

| | | | | | | Mixing | |
|---|---|---|---|---|---|---|---|
| Cellulose | | Cross- | Softening | | | Time | Temp |
| Type | Solvent | linkers | Agent | Biopolymer | Surfactants | (h) | (° C.) |
| NBSK | H₂O | PVA, | PEG | None | SDS, | 1.25 | 85 |
| | | Oxalic | | | “Tween” ® 80 | | |
| | | Acid | | | | | |
| NBSK | H₂O | PVA, | PEG | CMC | SDS, | 1.25 | 85 |
| | | Oxalic | | | “Tween” ® 80 | | |
| | | Acid | | | | | |
| NBSK | H₂O | PVA, | PEG | HEC | SDS, | 1.25 | 85 |
| | | Oxalic | | | “Tween” ® 80 | | |
| | | Acid | | | | | |
| NBSK | H₂O | FDCA | PEG | HEC | SDS, | 1.25 | 85 |
| | | | | | “Tween” ® 80 | | |
| Eucalyptus | H₂O | PVA, | PEG | None | SDS, | 1.75 | 85 |
| Pulp | | Oxalic | | | “Tween” ® 80 | | |
| | | Acid | | | | | |
| Eucalyptus | H₂O | Oxalic | PEG | HEC | SDS, | 1.75 | 85 |
| Pulp | | Acid | | | “Tween” ® 80 | | |
| Eucalyptus | H₂O | FDCA | PEG | HEC | SDS, | 1.75 | 85 |
| Pulp | | | | | “Tween” ® 80 | | |
| Eucalyptus | H₂O | PVA, | PEG | None | SDS, | 1.75 | 85 |
| Pulp | | Succinic | | | “Tween” ® 80 | | |
| | | Acid | | | | | |
| Eucalyptus | H₂O | Succinic | PEG | HEC | SDS, | 1.75 | 85 |
| Pulp | | Acid | | | “Tween” ® 80 | | |

TABLE 6
Characteristics of the product formulations with cellulose
emulsions/dispersions in comparison to acrylic emulsion.

| | Cellulosic | |
|---|---|---|
| Characteristic | Emulsion/Dispersion | Acrylic Emulsion |
| Solids content (%) | 20-50 | 50-69 |
| Average particle size (μm) | <1.0 | 0.1-0.3 |
| pH | 2.0-6.5 | 4.0-9.7 |
| Density (kg/L) | 1.05-1.20 | 1.06-1.30 |

Results: During the drying process, coalescence took place, resulting in the successful formation of continuous films as water evaporated. The outcome was a cohesive and homogeneous layer of functionalized cellulosic films (see FIG. 8). These films hold potential for diverse applications, including their use as binders, adhesives, or films.

### Example 7

### Analysis of Cellulosic-Based Adhesives and Binders

This example describes the analysis via tensile testing of the functionalized cellulosic films as obtained or described in Example 6.

Tensile experiments were performed by dynamic mechanical analysis (DMA 850, TA Instruments) on cut product (or cellulosic film) strips with an applied strain of 10% per minute.

Results: As shown in Table 7, the tests showed that the tensile strength and elongation at break values were within a similar range to those of typical acrylic emulsions.

TABLE 7
Analytical characteristics of the cellulosic
films as obtained in Example 6.

| Characteristic | Cellulosic Film | Acrylic Emulsion |
|---|---|---|
| Tensile strength (N/mm²) | 1.5-2.3 | 2.6 |
| Elongation at break (%) | 100-300 | 150-450 |

### Example 8

### Cellulosic-Based Adhesives and Binders: Product Formulation Using Cellulose Emulsion/Dispersion with Additives and Crosslinkers

This example outlines the preparation of cellulose-based adhesive/binder product formulations at a 20-fold scale using solvent-recovered cellulose either as emulsions and/or dispersions, along with various additives, to demonstrate their adhesive, binding, and coalescence properties.

Materials and Methods: A representative experimental procedure for preparing 250-300 g of a product formulation involved initially combining 120-130 g of solvent-recovered cellulose emulsions or dispersions with deionized water. This mixture was stirred at an ambient temperature for approximately 15 minutes to ensure uniform dispersion of the cellulose phase. Subsequently, predetermined quantities of various functional additives such as plasticizers, crosslinkers, or rheology modifiers were incorporated sequentially. Each additive addition was accompanied by a small amount of deionized water and followed by gentle stirring for 5 to 10 minutes at room temperature to promote effective integration without premature interaction. The final additives introduced were surfactants, typically delivered as aqueous stock solutions to facilitate dispersion and interfacial stabilization. Once all components were combined, the formulation was subjected to continuous stirring at an elevated temperature of 85° C. for 2.4 to 2.5 hours. This thermal treatment yielded homogeneous, water-based cellulosic adhesive or binder formulations specifically developed to assess coalescence behavior and film-forming characteristics. Following this, 2-4 g aliquots of the heated formulations were dispensed into Petri dishes and oven-dried under controlled conditions, with drying times ranging from 20 to 45 minutes at temperatures between 85 and 120° C., to produce solid films for subsequent analysis.

TABLE 8
Formulations of cellulose-based adhesives/binders developed through
the combination of various bio-based additives and crosslinkers.

| | | | | | | Mixing | | |
|---|---|---|---|---|---|---|---|---|
| Cellulose | | Cross- | Softening | Bio- | | Time | Temp | |
| Type | Solvent | linkers | Agent | polymer | Surfactants | (h) | (° C.) | pH |
| Eucalyptus | H₂O | PVA, | PEG | None | SDS, | 2.4 | 85 | 1.8- |
| Pulp | | Oxalic | | | Tween 80 | | | 2.0 |
| | | Acid | | | | | | |
| Eucalyptus | H₂O | FDCA | PEG | HEC | SDS, | 2.5 | 85 | 2.6- |
| Pulp | | | | | Tween 80 | | | 2.8 |

TABLE 9
Curing studies with varying temperature and time for cellulose-
based adhesives/binders product formulations

| Formulation # | Curing Time (min) | Temp (° C.) | Solids Content (%) |
|---|---|---|---|
| 1 | 35 | 85 | 21 |
| 1 | 25 | 105 | 21 |
| 1 | 25 | 110 | 19 |
| 1 | 20 | 120 | 20 |
| 2 | 45 | 85 | 23 |
| 2 | 35 | 105 | 18 |
| 2 | 25 | 110 | 20 |
| 2 | 22 | 120 | 26 |

Results: During the drying phase, the gradual evaporation of water facilitated the coalescence of dispersed components, leading to the successful formation of continuous, defect-free films. This process resulted in the development of cohesive and homogeneous layers composed of functionalized cellulosic materials, with final solids contents ranging from 18% to 26%, depending on the formulation. The resulting films exhibited favorable structural integrity and surface uniformity, underscoring their potential for a wide range of applications. These include sustainable binders in composite materials, environmentally friendly adhesives, or standalone functional films in coatings, packaging, or barrier technologies.

### Example 9

### Adhesion Performance of Cellulose-Based Adhesive/Binder Product Formulations: Lap Shear Strength Testing

This example details lap shear testing conducted to evaluate the adhesive strength of the cellulose-based adhesive/binder product formulations.

Materials and Methods: In a representative experimental procedure, cellulose-based adhesive and binder formulations (Formulation 1 and Formulation 2 of Example 8) were evaluated for adhesive performance using lap shear testing. Each formulation was applied to a 4-5 mm section at the end of Northern Bleached Softwood Kraft (NBSK) paper strips, measuring approximately 2.5-5 mm in width and 20-30 mm in length. The treated ends of these paper strips were then adhered to uncoated cardboard substrates, each approximately 5-10 mm wide and 40-50 mm long, with care taken to maintain a consistent bonding area of 2 cm² for each test specimen. To ensure even distribution of adhesive and consistent contact pressure across samples, an acrylic sheet was placed over the bonded regions, and a 750 g weight was applied across three assembled samples simultaneously. The samples were then transferred to a laboratory oven and cured at 50° C. for one hour to allow the adhesive to fully set. After curing, shear strength measurements were conducted using a dynamic mechanical analyzer (TA Instruments DMA 850). Each sample was subjected to tensile loading at a constant strain rate of 2% per minute, applied at a 0° angle relative to the adhesive bond line, until bond failure occurred. The peak force recorded during this test was used to quantify the adhesive strength of the respective formulations.

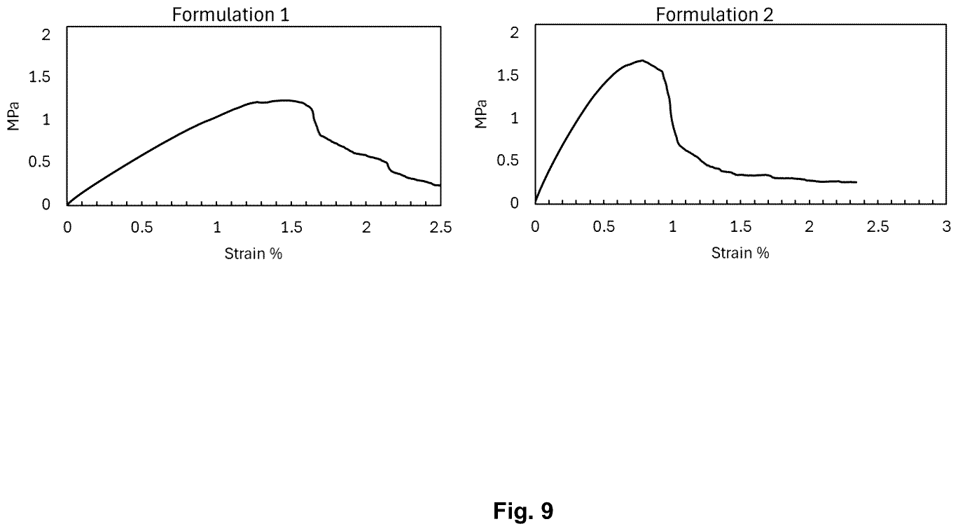

Results: The experimental results indicated that Formulation 1 exhibited a maximum shear strength of 1.24 MPa, whereas Formulation 2 achieved a notably higher shear strength of 1.68 MPa, as illustrated in FIG. 9. This significant enhancement in adhesive performance demonstrates that both Formulation 1 and 2 approaches the adhesive strength typically observed in comparable commercial products. The improved bonding capability of Formulation 1 and 2 highlights its potential suitability for practical applications where moderate mechanical strength and reliable adhesion are required, such as in paper laminates, lightweight composites, or sustainable packaging materials.

The foregoing discussion has been presented for purposes of illustration and explanation, and is not intended to limit the disclosed method to the particular forms disclosed. Although specific versions, variations, and modifications have been described, other variations and modifications may be apparent to those skilled in the art in view of the present disclosure and are considered within the scope of the appended claims. It is intended that the claims encompass all alternative, interchangeable, and equivalent structures, functions, ranges, or steps, whether or not expressly disclosed herein, to the fullest extent permitted by law. No subject matter is intended to be dedicated to the public unless expressly stated. All references cited herein are incorporated by reference in their entirety.

What is claimed is:

1. A method of making a composition of matter, the method comprising:
(a) dissolving cellulose in a first solvent to yield a first solution; and then
(b) adding to the first solution an anionic surfactant, a non-ionic surfactant, water, or a combination thereof, in an amount and under conditions to yield a second solution comprising a stable dispersion or emulsion containing cellulose; and then
(c) removing at least a portion of the first solvent to yield a first composition of matter.

2. The method of claim 1, wherein in step (a) the first solvent comprises an ionic liquid or a deep eutectic solvent.

3. The method of claim 1, wherein in step (a) the first solvent comprises a deep eutectic solvent, and the cellulose is dissolved in the first solvent at a concentration ranging from about 1 wt % to about 50 wt %, at a temperature between about 20° C. and about 100° C.

4. The method of claim 1, wherein in step (a) the first solvent comprises an ionic liquid, and the cellulose is dissolved in the first solution at a concentration ranging from about 1 wt % to about 25 wt %, at a temperature between about 17° C. and about 150° C.

5. The method of claim 1, wherein in step (b) the anionic surfactant(s), the nonionic surfactant(s), or a mixture of anionic and nonionic surfactants are added to the first solution at a concentration ranging from about 0.5 wt % to about 5 wt % of the first solution.

6. The method of claim 1, wherein in step (b) water alone is added to the first solution at a concentration ranging from about 0.5 wt % to about 50 wt % of the first solution.

7. The method of claim 1, wherein in step (c), at least 90 wt % of the first solvent is removed.

8. The method of claim 1, further comprising, after step (c):
(d) recycling at least a portion of the first solvent removed in step (c).

9. The method of claim 8, wherein at least a portion of the first solvent recycled in step (d) is used as the first solvent in step (a).

10. The method of claim 1, wherein the cellulosic dispersion or emulsion formed in step (b) has a mean particle size ranging from about 0.1 μm to about 50 μm, as measured by light scattering.

11. The method of claim 1, wherein the first composition of matter formed in step (c) comprises at least 85% cellulose by dry weight.

12. The method of claim 1, further comprising mixing the first composition of matter formed in step (c) with at least one bio-based additive to produce a second composition of matter, wherein the bio-based additive comprises one or more of a bio-based polymer, a crosslinking agent, or a combination thereof.

13. The method of claim 12, further comprising
adding water to the first composition of matter formed in step (c) prior to adding the at least one bio-based additive; and
agitating the second composition of matter at about 50° C. to about 85° C. for about 1 to about 2 hours.

14. The method of claim 12, wherein the bio-based additive comprises no more than 45% by dry weight of bio-based polymer, and no more than 15% by dry weight of crosslinking agent.

15. The method of claim 12, wherein the second composition of matter comprises no more than 65% by dry weight of cellulose.

16. The method of claim 12, wherein overall solids content of the second composition of matter ranges from about 15 wt % to about 50 wt %.

17. The method of claim 12, wherein the second composition of matter exhibits a maximum shear strength in the range of about 1.24 MPa to about 1.68 MPa.

18. The method of claim 12, wherein the second composition of matter is biodegradable and compostable.

19. The method of claim 12, wherein the second composition of matter contributes to a reduction of up to 90% in carbon footprints relative to conventional commercially available adhesives.

20. A method to form a film, the method comprising:
(a) casting a composition of matter made by claim 1 onto a substrate, whereby a film is formed.

21. The method of claim 20, further comprising, after step (a):
(b) drying the composition of matter.

22. The method of claim 20, wherein the film so formed has a tensile strength of from about 1.5 N/m² to about 2.3 N/m².

23. The method of claim 20, wherein the film so formed has an elongation at break value of from about 100% to about 300%.

24. A film made by the method of claim 20.
